(19) United States
(12) Patent Application Publication
(10) Pub. No.: US 2014/0053971 A1
(43) Pub. Date: Feb. 27, 2014

(54) MACHINE FOR TRANSFERRING A PROTECTIVE LAYER FOR A SUBSTRATE AT HIGH TEMPERATURE AND UNDER PRESSURE, AND ASSOCIATED METHOD

(71) Applicants: José Oliveira, Villiers Sur Marne (FR); André Pustel, Le Perreux Sur Marne (FR)

(72) Inventors: José Oliveira, Villiers Sur Marne (FR); André Pustel, Le Perreux Sur Marne (FR)

(73) Assignees: HOLOGRAM INDUSTRIES, Bussy-Saint-Georges (FR); ASTEA, Bussy-Saint-Georges (FR)

(21) Appl. No.: 14/002,472

(22) PCT Filed: Mar. 1, 2012
(86) PCT No.: PCT/FR2012/050435

§ 371 Date: Nov. 8, 2013

(30) Foreign Application Priority Data
Mar. 1, 2011 (FR) 1151634

(51) Int. Cl. B32B 38/18

(52) U.S. Cl. CPC B32B 38/185
USPC 156/234; 156/495; 156/378; 156/361

(57) ABSTRACT

The invention relates to a machine for transferring a protective layer for a substrate at high temperature and under pressure, said protective layer being mainly intended to protect a flat substrate.

### TECHNICAL FIELD OF THE INVENTION

The invention relates to the field of transferring, at a high temperature and under pressure, a transfer layer or film onto substrates such as paper supports.

More precisely the invention relates to the transfer of at least one layer intended for the protection of a support such as an official identification document. The layer itself is preferably transparent and can intrinsically comprise optical security elements such as holograms or other elements of information that must be sealed on the official support.

### PRIOR ART

In this field many techniques have existed for a very long time and which evolve technically over time in order to render the final document (or substrate) as inalterable as possible.

High-temperature laminating techniques which can be divided substantially into two categories. The first uses two rotating cylinders one pressing and the other heating driving between them the substrate and the protective film.

This technique requires equipment of the roll laminator type where the adhesion of the protective film on the substrate (passport for example) is carried out along the contact generating line between the two cylinders thanks to the heat supplied by the heating cylinder and to the pressure of the second cylinder. This single line of contact induces relatively slow production rates if good quality adhesion is sought. In addition the quality of the adhesion is not optimum as the back pressure applied does not allow for a good penetration of the adhesive into the thickness i.e. in the fibre of the paper (when the substrate is constituted of paper). An improvement in this technique consists in multiplying the number of pairs of cylinders in contact but of course this has a cost that industrialists are not ready to support. The encumbrance is another disadvantage of this technique.

The applicant has filed a French patent application FR 2889482 relating to an improvement in this technique according to which a single drum is provided at the centre of the device, and a plurality of pressure means are arranged around it; the drum or the pressers produce heat. The disadvantage of such a device resides in that the substrate is curved when it is heated which can give rise to a problem afterwards when it is cooling; folds can form; in addition this type of laminator is necessarily intended for the laminating of documents intrinsically comprising a laminate and it does not allow for the use of laminating films in reels. In addition the curvature associated with the pressure of the cylinders or pressure rollers can, in the case of the application of an electronic passport, damage the RFID (Radio Frequency IDentification) components such as chip or antenna included in said passport.

A second laminating technique consists in hot pressing via thrusting between two jaws, the substrate and the protective film. Document WO 95/04657 describes a device of this type which comprises a pressure-applying member of which the surface is less than the conjugated member, referred to as sole. This device does not comprise means for separating the film with regards to the support; the only technically equivalent means consists in applying a sufficient tension on the film itself. This is therefore a force parallel to the surface of the substrate (document) and of the transfer film which is here brought into play for this function of separating the transfer film with regards to the laminate.

Most of the laminates that are used to transfer a protective layer (or film) onto a substrate (or document) are initially constituted of a stack of layers or films: a carrier film made of PET or equivalent material, a detachment layer of the wax type, a protective layer (mechanical or chemical) of the varnish type, a layer of glue which adheres to the substrate to be protected. Optionally between the protective layer and the layer of glue can be interposed a layer comprising an image of the hologram type and/or a transparent layer with a high optical index. Of course following the transfer, the carrier film and the detachment layer are separated from the substrate, generally rewound onto a specific reel; they cannot be reused.

### DESCRIPTION OF THE INVENTION

The invention aims to overcome the disadvantages of prior art and in particular propose equipment according to which the transfer is rapid; of which the cost is modest in particularly by the low number of means implemented; which allows for an effective gluing over large surfaces, which preserves the brilliance of the document.

For this is proposed according to a first aspect of the invention a machine for transferring, at high temperature and under pressure, at least one layer, known as a transfer layer, that is a constituent part of a multilayer laminate, said transfer layer being intended in particular for the protection of a flat substrate, comprising:
a press comprising a first and a second flat jaws arranged horizontally and mobile vertically in relation to one another between a first position arranging a space between them and a second position where their facing surfaces are in contact, with at least one of said jaws producing heat
at least one first motorised reel around which said laminate is initially wound, a second reel around which said laminate is wound after the transfer
means for guiding and controlling the tension of said laminate between said first and said second reel
motorised means for the relative displacement of one of said first or second jaw, between said first and said second position

According to the invention, the machine further comprises: means for displacing the laminate longitudinally and horizontally over a given distance on either side of a transfer position; and mechanical means arranged on either side of said jaws in order to detach said substrate covered with said transfer layer with regards to the laminate.

More precisely, said means for detaching the substrate include at least one element of the knife type arranged perpendicularly to the direction of travel of the laminate, and comprised of at least one edge defined by the intersection of a first plane parallel to the plane of the jaws and of a second plane oriented with regards to said first plane in such a way that the edge is sharp. As such it is the translaminar shear forces i.e. perpendicular to the plane of the laminate which make possible the detaching of the substrate to which is glued the transfer layer, with regards to the rest of the laminate.

Moreover, the element of the knife type is arranged in longitudinal proximity to one of the edges of one of the jaws and it is arranged with regards to said means for displacement or said means for guiding the laminate in such a way as to deviate the laminate on said sharp edge by an angle between about 45° and 90°.

This particular arrangement allows the substrate provided with its protective layer to be detached practically naturally, by its own weight, from the carrier film. The number of parts brought into movement is reduced, which makes the machine particularly simple and reliable.

Furthermore, according to a particular embodiment, said means for displacing the laminate on either side of the transfer position include two cylinders of which one is motorised, between which is displaced said laminate which is driven by contact by at least one of said cylinders.

These are therefore alternative displacements, in two opposite directions which make it possible to delaminate a first then a second zone of the substrate with regards to the carrier film.

Advantageously, the total surface of said substrate corresponds substantially to the joint surface of the first and of the second jaw placed facing. The transfer surface can therefore be substantial, of the same magnitude as that of the substrate.

Interestingly, the machine further comprises at least one cell intended to locate the position of said laminate with regards to the substrate before the transfer. Said cell cooperates with means for controlling the displacement and/or the tension of the laminate; this allows for a precise positioning of the laminate with regards to the substrate before the transfer.

Moreover, the machine according to the invention further comprises means for adjusting the heating of at least one of said jaws, in temperature and/or in duration.

According to the invention, the machine further comprises means for adjusting the application pressure between the first and the second jaw.

Characteristically the machine further comprises means for controlling and/or adjusting the speed of travel of said laminate. As such several speeds of travel for the laminate are possible: rapid for a global approach to the substrate; slow for a more precise positioning.

Without leaving the scope of the invention, the surface of at least one of said jaws placed facing the other surface is provided with bosses and/or protuberances and/or recesses. Particular, more sophisticated uses can require these elements in order to reinforce the level of safety or to create tactile zones.

“Surface of at least one of the jaws” means the surface itself of one of the jaws or the surface of a fixed plate that can be detached with regards to one of the jaws.

Moreover, the surface of at least one of said jaws placed facing the other surface can have specific functional zones.

This invention further relates to a method for transferring at high temperature and under pressure between a first and a second jaw, of at least one transfer layer being initially part of a laminate initially wound around a first reel, over a substantially flat substrate characterised in that it consists in detaching by shearing said layer once it is glued to said substrate, with the detaching being obtained by an alternative displacement of said substrate with regards to a sharp edge of at least two elements arranged on either side of said jaws in contact with said laminate which, after the transfer, is wound around a second reel.

### BRIEF DESCRIPTION OF THE FIGURES

Other characteristics, details and advantages of the invention shall appear when reading the following description, in reference to the annexed figures, which show:

FIG. 1, a front view of a machine for transferring according to an embodiment of the invention;

FIG. 2, a front view of said machine during a 2nd step of the transfer method;

FIG. 3, a front view of said machine during a 3rd step of the transfer method; and

FIG. 4, a front view of a plate or flat jaw that comprises a press according to an embodiment of the invention.

For increased clarity, identical or similar elements are marked with identical reference signs over all of the figures.

### DETAILED DESCRIPTION OF AN EMBODIMENT

In a conventional and known manner the machine for transferring according to the invention substantially comprises: a press constituted of a first 1 and of a second 2 jaws arranged respectively one on top of the other and which each extend in a horizontal or substantially horizontal plane. The at least one of the jaws produces heat; according to the preferred embodiment it is the upper jaw 1 which produces heat. Of course details on the elements and connections useful for the heating function are not provided here as it is a common practice for those skilled in the art. Preferably, the invention provides means for adjusting the heating, in temperature and/or in duration. Those skilled in the art will choose a setting according to the case under consideration, in particular according to the nature of the materials, their thickness.

Jaw means a flat plate that is part of the frame of the machine, or an additional specific plate fixed onto such flat plate. In the case of a specific plate, the latter can be changed easily, according to the needs and constraints of the user.

The jaws 1, 2 are mobile in relation each other, here vertically, between a first position arranging a space between them and a second position where their facing surfaces are in contact. The first position corresponds to step of setting into place or of withdrawing the flat substrate, while the second position corresponds to a gluing of the laminate 10 onto the substrate 100.

As shall be explained in more detail hereinafter, and interestingly, the total surface of the substrate 100 to be protected corresponds substantially to the joint contact surface between the first 1 and the second 2 jaw.

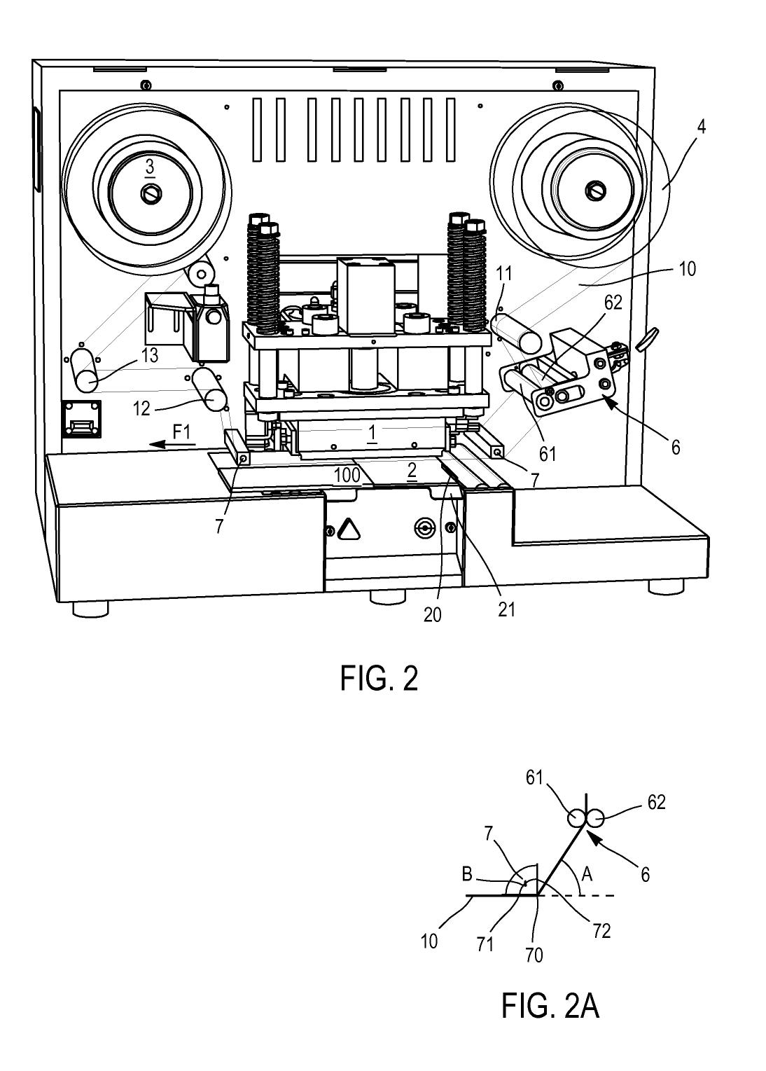

The lower jaw 2 can include means 20, 21 for positioning and guiding the substrate 100, such as can be seen in FIG. 2.

Optionally, rollers 22 can be juxtaposed longitudinally to the lower jaw 2 in order to facilitate the translation of the substrate on either side of the jaw 2.

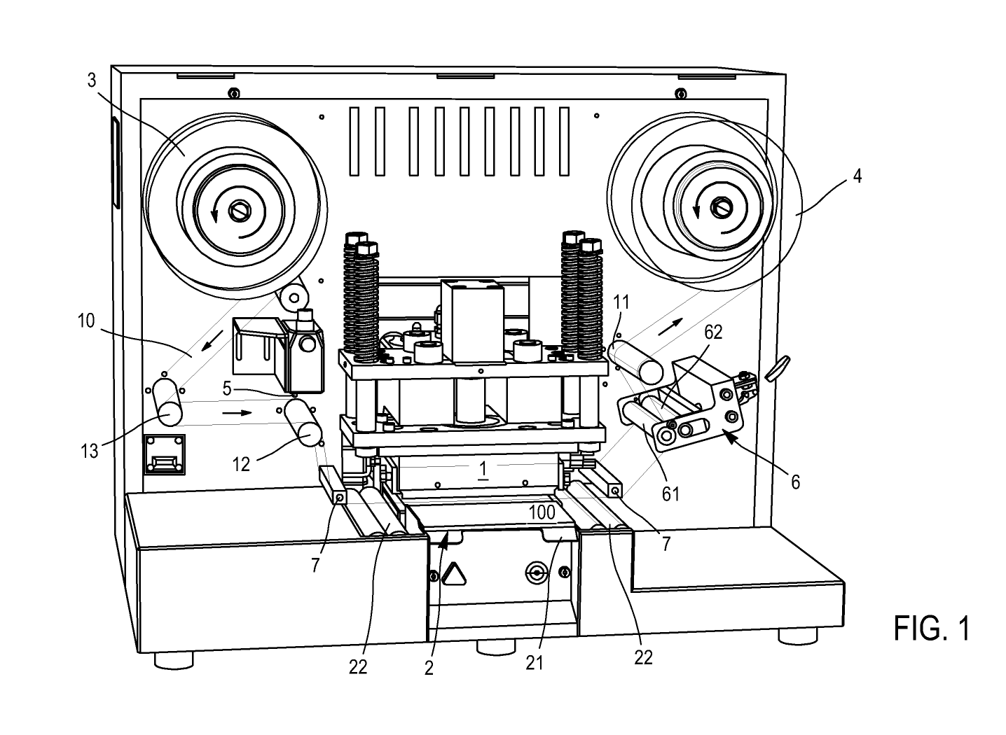

The invention further provides means for adjusting the application pressure of the first jaw 1 against the second jaw 2. Those skilled in the art will adapt the pressure according to the case at hand. For the purposes of illustration, the pressure between said jaws is approximately 9 kg/cm2 for associated return springs (not referenced but which can be seen in FIG. 1 for example), here numbering four, which each have a stiffness of a magnitude of 25 Kg/cm.

In addition for certain specific applications it may be interesting to create substrates of which all or a portion of the surface is not smooth but has surface irregularities. For example it may be sought to engrave on a surface of the substrate signs in Braille or any other marking having a tactile or optically variable effect. To do this, the surface of at least one of the jaws 1, 2 will be provided with bosses. According to another alternative have the same technical effect, an engraved plate can be fixed onto one of the jaws, more preferably but not necessarily on the upper jaw 1. As shall be seen further on, this characteristic can be an obstacle for the detaching of the protective film with regards to the laminate after the transfer since the surfaces in contact are more substantial.

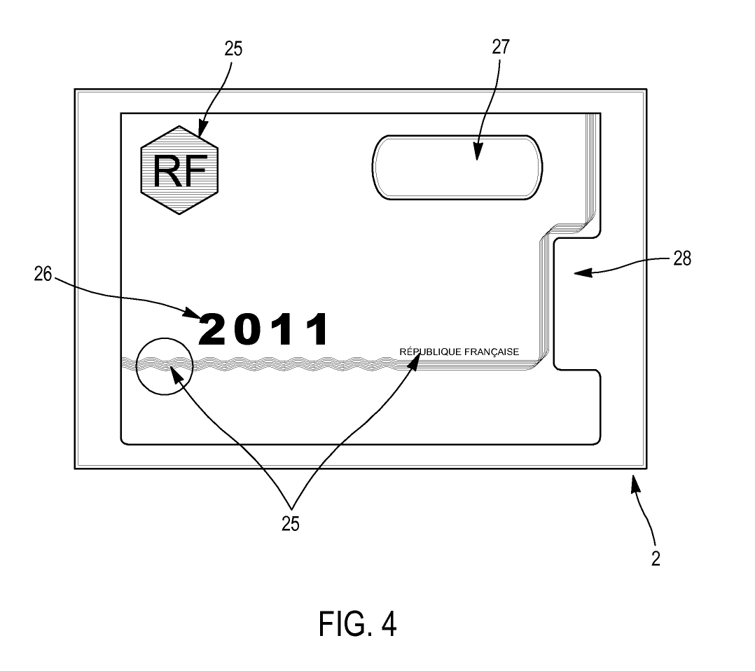

FIG. 4 shows particularly and more precisely, one of the jaw 2 (or plate) provided on the surface with different specific zones: for example at least one zone 25 is provided with embossing consisting in protuberances associated with recesses. Protuberances and recesses are defined in relation to the planar surface of said jaw 2. These surface irregularities are for example obtained by engraving of the plate 2, over a thickness between 10 and 200 micrometres, more preferably entre 20 and 100 micrometres. The engravings can take any form suited to the needs; FIG. 4 shows as such several undulated lines of embossing, as well as letters and symbols.

Moreover at least one of the jaws 1, 2 can have another type of specific functional zones, i.e. reserve zones: for example a zone 26 is provided in such a way that no transfer can take place therein. As such it is possible to change as desired the inscriptions provided in such a zone. Another functional zone 27 can make it possible to arrange a space for a signature or in order to leave apparent an embossing initially present on the substrate 100. Without leaving the scope of the invention, another functional zone 28 can be provided in order to align or visually locate the transfer layer with regards to the substrate 100.

Furthermore, a first reel 3 is provided in order to wind and store the laminate before the transfer. This reel 3 is motorised; its rotation speed is controlled by an internal unit in such a way that for example a first speed of travel of the laminate strip can be had, for example in order to unwind the reel in rapid mode in order to retrieve an image belonging to the laminate; a second rotation speed is provided in order to unwind in slow mode the laminate in order to, in liaison with a position detector 5 of the laminate, precisely position the laminate 10 with regards to the substrate before any transfer.

A second reel 4 is provided and intended to allow for the winding of the support of the laminate 10 after the transfer. According to the illustrative figures the second reel 4 is placed at the same height as the first reel 3, opposite the reel 3. This is an arrangement among others, which is in no way restrictive.

As can be seen in the different figures, the laminate 10 extends between the first and the second reel according to a path in particular defined by means for guiding and tensioning, constituted of cylinders 11, 12, 13. This path is of course chosen by those skilled in the art according to the constraints of encumbrance, orientation and others.

In a particularly interesting manner, the machine further comprises means 6 for displacing the laminate 10 longitudinally and horizontally, over a given distance, on either side of the transfer position. More precisely the means 6 include a first cylinder 61 and a second cylinder 62 between which the laminate 10 passes, in the NIP formed as such. The NIP provides an extremely precise positioning, by preventing the relative slippages of the substrate with regards to the cylinders. One of the cylinders is motorised, the other not necessarily. As the laminate is in tension and in contact with the cylinders 61, 62, the rotation of one of the cylinders drives the laminate in translation, in one direction or the other according to the direction of rotation of the cylinders 61, 62. The arrow F1 in FIG. 2 shows a translation in one direction while the arrow F2 shows a translation in the opposite direction, as shall be explained hereinafter.

Moreover the machine according to the invention comprises mechanical means in order to detach the substrate covered with the transfer layer with regards to the laminate. These means here have the form of parts 7 of the knife type, arranged perpendicularly to the length or direction of travel of the laminate. The figures show the parts 7 in the form of a bar with a square cross-section; this is an embodiment of the invention that operates correctly. Other forms of detachment parts can be considered without leaving the scope of the invention.

As such, it appears appropriate that one of said parts 7 has a sharp edge 70 defined by the intersection of a first plane (or wall) 71 parallel to the plane of the jaws 1, 2 and of a second plan (or wall) 72 oriented with regards to the first plane 71 in such a way that the edge 70 is sharp. The angle B between the first 71 and second 72 planes is preferably between 20° and 90°.

The or each part 7 is arranged in the longitudinal vicinity of one of the edges (the transverse edge) of the jaws 1, 2. According to the preferred embodiment shown in FIGS. 1 to 3, two parts 7 are provided, arranged on either side of the jaws 1, 2, in such a way that the laminate 10 passes under the first plane 71 of each part 7. Between the two parts 7 the laminate 10 extends horizontally.

Furthermore one of the two parts 7 is arranged with regards to the means 6 in such a way that the laminate is deviated on the sharp edge 70 of the part 7, by an angle A between 45° and 90°. This angle must allow for a clear-cut deviation of the laminate at this level.

As shown successively in FIGS. 1, 2 and 3: the substrate 100 is first placed on one of the jaws 2 as shown in FIG. 1. The laminate thus extends horizontally between the first 1 and the second jaw 2. The two parts 7 delimit the horizontal travel of the laminate. The first jaw 1 is then brought closer to the second jaw 2, then they are pressed against one another while heating one of the jaws 1, 2. The transfer at a high temperature and under pressure takes place as such, preferably over the entire surface of the substrate which corresponds to the contact surface of the jaws 1,2 according to an advantageous but not mandatory embodiment of the invention.

The jaws 1, 2 are separated from each other and it is understood that the substrate 100 sticks entirely to the laminate 10.

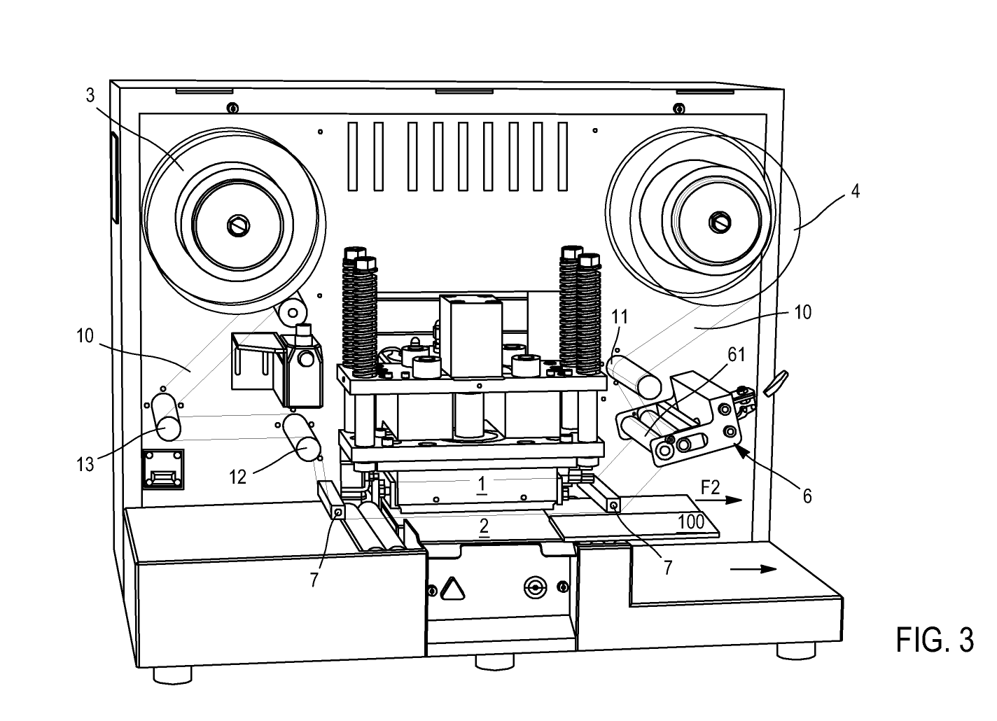

This then entails detaching the carrier film with regards to the protective layers or others now glued onto the substrate 100. To do this, a rotation of one of the cylinders 61 or 62 of the part 6 is controlled, which drives a translation of the laminate 10, according to the arrow F1 as shown in FIG. 2. This movement displaces the substrate 100 until it exceeds by a first length the part 7 placed in the vicinity. In light of the practically vertical orientation of the laminate 10 beyond the part 7 and the associated sharp edge 70, a detaching of the substrate 100 is obtained over the length which extends beyond the sharp edge 70. The process is continued by controlling the rotation of one of the cylinders 61 or 62 in the direction opposite that of the preceding step. This brings the substrate into the position shown in FIG. 3 where the latter exceeds (according to the arrow F2) the second part 7 over a second length. In the same way over this length the substrate 100 will be separated from the laminate 10.

According to the settings, the first and the second length combined can correspond to a portion or to all of the total length of the substrate. The alternating movements of the substrate, to which is glued the laminate, in alignment with the second plane 72 of the part 7, allow for the rupture of the detachment layer of the laminate by the shear forces which are applied therein. The alternating passages of the laminate in the alignment of the second plane 72 allow for the rupture by shearing of the detachment layer of the laminate. A clear-cut rupture of the layers is therefore created by the application of a force perpendicular to the plane of the laminate. These forces are called translaminar in the field. It is common and known that shear forces referred to as interlaminar i.e. parallel to the plane of the laminate, allow for a detachment of the layers. Here, in a new and unexpected way, it is the forces directed perpendicularly to the plane of the laminate which create the detaching.

Following this step of detaching, only the carrier film and the detachment layer constitute the laminate 10; the transfer layer then adheres entirely to the substrate 100 which falls via gravity for example on the jaw 2. In any case, the substrate 100 detaches itself, by its own weight, with regards to the laminate 10. It falls on the jaw 2 or on the cylinders 22 arranged directly below.

No mobile means are used to obtain this detaching, in such a way that the process is very reliable. No specific means for displacing the substrate are provided, which reduces the number of parts required for the operation of the machine.

The duration of transfer is rather short, of a magnitude of 2 to 3 seconds; heating between 100 and 150° C. is sufficient to carry out the transfer of a thick varnish of a few micrometres onto a paper (substrate) having a thickness less than 1 millimetre. The layer of glue has a thickness of 8 to 10 micrometres. The machine according to the invention therefore allows for a static transfer in that both the document and the substrate are immobilised during the duration of the transfer. The fact that the document is well immobilised during the transfer allows for better alignment and better positioning.

Furthermore a precise setting of the heating is carried out, of a magnitude of 1/10° C. thanks to suitable electronic components. The machine according to the invention can advantageously include a means that prevents the transfer if a minimum temperature, referred to as the setting, is not reached on the first or on the second jaw.

This is therefore an interesting combination of means such that the knife or knives 7 and specific displacements of the laminate 10 which allow not only to effectively transfer a protective film onto a substrate 100, but also to detach said film glued onto the substrate with regards to the laminate 10, simply and reliably.

1. A machine for transferring, at high temperature and under pressure, at least one transfer layer that is a constituent part of a multilayer laminate, the transfer layer being intended for the protection of a flat substrate, comprising:
a press constituted of a first and of a second flat jaws arranged horizontally and mobile vertically in relation to each other between a first position arranging a space between them and a second position where their facing surfaces are in contact, with at least one of the jaws producing heat;
at least one first motorised reel around which the laminate is initially wound, a second reel around which the laminate is wound after a transfer;
means for guiding and controlling the tension of the laminate between the first and the second reel;
motorised means for the relative displacement of one of said first or second jaw, between the first and the second position;
means for displacing the laminate longitudinally and horizontally over a given distance on either side of a transfer position; and
mechanical means arranged on either side of the jaws in order to detach the substrate covered with the transfer layer with regards to the laminate.

2. The machine according to claim 1, wherein the means for detaching the substrate include at least one element of the knife type arranged perpendicularly to a direction of travel of the laminate, and constituted of at least one edge defined by an intersection of a first plane parallel to a plane of the jaws and of a second plane oriented with regards to the first plane in such a way that the edge is sharp.

3. The machine according to claim 2, wherein the element of the knife type is arranged in a longitudinal vicinity of one of the edges of one of the jaws and in that it is arranged with regards to the means for displacing or the means for guiding the laminate in such a way as to deviate the laminate on the edge by an angle between about 45° and 90°.

4. The machine as claimed in claim 1, wherein the means for displacing the laminate on either side of the transfer position include two cylinders of which one is motorised, between which is displaced the laminate which is driven by contact by at least one of the cylinders.

5. The machine according to claim 1, wherein the total surface of the substrate correspond substantially to a joint surface of the first and of the second jaws placed facing.

6. The machine as claimed in claim 1, further comprising at least one cellule intended to locate a position of the laminate with regards to the substrate before the transfer.

7. The machine according to claim 6, wherein the cellule cooperates with means for controlling the displacement and/or the tension of the laminate.

8. The machine as claimed in claim 1, further comprising means for adjusting heating of at least one of the jaws, in temperature and/or in duration.

9. The machine as claimed in claim 1, further comprising means for adjusting application pressure between the first and the second jaw.

10. The machine as claimed in claim 1, further comprising means for controlling and/or adjusting speed of travel of the laminate.

11. The machine as claimed in claim 1, wherein the surface of at least one of the jaws placed facing the other surface is provided with bosses and/or protuberances and/or recesses.

12. The machine as claimed in claim 1, wherein the surface of at least one of the jaws placed facing the other surface has specific functional zones.

13. A method for transferring at a high temperature and under pressure between a first and a second jaw, of at least one transfer layer being initially part of a laminate initially wound around a first reel, over a substantially flat substrate, comprising: detaching by shearing the transfer layer once it is glued to the substrate, with the detaching being obtained by an alternating displacement of the substrate with regards to a sharp edge of at least two elements arranged on either side of the jaws in contact with the laminate which, after a transfer, is wound around a second reel.
